(19) United States
(12) Patent Application Publication
(10) Pub. No.: US 2007/0200819 A1
(43) Pub. Date: Aug. 30, 2007

(54) Display panel and method for driving the same

(75) Inventor: Moon Bong Song, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/710,954

(22) Filed: Feb. 27, 2007

(30) Foreign Application Priority Data
Feb. 27, 2006 (KR) 10-2006-0018893
Apr. 25, 2006 (KR) 10-2006-0037176

(51) Int. Cl. G09G 3/34

(52) U.S. Cl. 345/107

(57) ABSTRACT

A display device and a method for driving the same are disclosed. In the method for driving a display panel provided with a plurality of scan electrodes and a plurality of data electrodes, the method according to an embodiment includes applying a first voltage to each of pixels at a first frame; and applying a second voltage to each of pixels at a second frame, wherein the second voltage is determined by a variation of a reflection ratio at each of the pixels.

This application claims the priority benefit of the Korean Patent Application No. 10-2006-0018893, filed on Feb. 27, 2006, which is hereby incorporated by reference as if fully set forth herein. Also, this application claims the priority benefit of the Korean Patent Application No. 10-2006-0037176, filed on Apr. 25, 2006, which is hereby incorporated by reference as if fully set forth herein.

### BACKGROUND OF THE INVENTION

1. Field of the Invention

The present invention relates to a display panel and a method for driving the same, and more particularly, to an electronic paper display device and a method for driving the same, in which the picture quality of the display device is improved and the high response speed is obtained.

2. Discussion of the Related Art

A digital paper display has been developed as a display device for the next generation, which will substitute for a liquid crystal display, a plasma display panel, and an electroluminescence device. In particular, an electronic paper is a display device that can display texts or images in a flexible substrate such as a thin type plastic provided with several million beads scattered in an oil hole. Accordingly, the electronic paper can be recycled several million times and is expected to be substituted for the existing printing media such as books, papers, magazines, and the like.

The aforementioned electronic paper display device is a core device of a flexible (or paper) display, and is based on electrophoresis which applies an electromagnetic field to a conductive material to allow the conductive material to have mobility. In more detail, the electronic paper display device distributes fine particles having conductivity between thin type flexible substrates and then displays data using variations in the arrangement of fine particles (or toner particles) according to a variation in the polarity of an electromagnetic field. An electrophoresis type electronic paper has been proposed, in which a dispersion solution of dispersion particles and a colored solution is micro-capsulated and then arranged between opposing substrates. The electronic paper covers a creative concept called a capsulated electrophoresis ink.

The capsulated electronic paper, as shown in FIG. 1 according to a related art, includes transparent microcapsules containing black particles 40 and white particles 30 in colored dielectric fluids. The capsulated electronic paper is mixed with a binder 50 and then arranged between upper and lower transparent electrodes 20 inscribed in a substrate 10. If a positive voltage is applied to the capsulated electronic paper, negatively charged ink particles are moved to a surface to display their color. Also, if a negative voltage is applied to the capsulated electronic paper, the ink particles are downwardly moved to allow a user to view colors of the fluids. In this way, texts or images are displayed.

Furthermore, contrary to the aforementioned electrophoresis which uses mobility in the solution, an electronic paper based on electrophoresis which does not use the solution has been recently proposed. In other words, two kinds of particles having different colors and different charging properties are sealed between two substrates, and an electric field is applied from a pair of electrodes formed at one of the substrates or both of them to the particles, wherein at least one of the substrates is transparent. At this time, the particles are soared and moved by a Coulomb force to display picture images.

An example of the cell structure of this dried electronic paper display device is shown in FIG. 2 according to a related art. As shown in FIG. 2, the cell structure of the dried electronic paper display device includes upper and lower substrates 160 and 110 formed of plastic or glass, upper and lower electrodes 170 and 120 formed of indium tin oxide (ITO) respectively on the upper and lower substrates 160 and 110 to apply a driving voltage of a device, a barrier wall 130 separating cells from each other, and black positive (+) charging particles 140 and white negative (−) charging particles 150 existing between the two electrodes. In the electronic paper display device constructed as above, if a sufficient voltage is applied to the upper electrode 170 and the lower electrode 120, the charging particles 140 and 150 are pulled to their respective electrodes depending on the polarities of the applied electrodes.

For example, if a negative (−) voltage is applied to the lower electrode 120 and a positive (+) voltage is applied to the upper electrode 170, the black charging particles 140 positively charged by the Coulomb force are moved to the lower substrate 110 while the white charging particles 150 negatively charged by the Coulomb force are moved to the upper substrate 160. Since the white charging particles 150 are located toward the upper substrate 160, the electronic paper display device is viewed as a white color when viewed from the outside. By contrast, if the positive (+) voltage is applied to the lower electrode 120 and the negative (−) voltage is applied to the upper electrode 170, the negatively charged white charging particles 150 are moved to the lower substrate 110 while the positively charged black charging particles 140 are moved to the upper substrate 160, whereby a black color is displayed. Accordingly, after a voltage is applied to the electronic paper display device to allow all the cells to be viewed as a white color, its opposite voltage is applied to desired cells only to allow the cells to be viewed as a black color, whereby pictures or texts are displayed.

As described above, the electronic paper which displays picture images through a rotation or motion of particles using the electrophoresis is susceptible to a variation of cells depending on the voltage applied between the upper electrode and the lower electrode. However, if the aforementioned electronic paper is driven by an existing simple matrix mode, the difference in the amount or speed between the fine particles occurs.

FIG. 3 illustrates a simple matrix driving method according to the related art. When the simple matrix driving method is applied to a passive matrix type electronic paper display panel according to the related art, the operation of the electronic paper display panel will be described. As shown in FIG. 3, a plurality of data lines (upper electrode lines) and a plurality of scan lines (lower electrode lines) (first scan line˜Nth scan line) are provided in a matrix arrangement. In this case, a scan pulse is applied to an electronic ink display device connected with the first scan line, wherein the scan pulse is dropped from a ground voltage to a predetermined negative voltage (−Vs). At this time, a data pulse is applied to a plurality of data lines D1-Dm provided in the display panel for a time period when the scan pulse is applied to the display device, whereby the display devices are operated. The ground voltage is applied to the other scan lines to which the scan pulse is not applied. This operation is performed for all the scan lines.

Once all the display devices are operated, a reset pulse having a predetermined negative voltage is applied to all the data lines D1˜Dm. The electronic paper, which displays picture images using the motion of particles moved by a driving voltage applied between both electrodes, has memory effect in which particles do not move even if a voltage is turned off. Accordingly, a step of erasing each cell is required before addressing new data information. In other words, since the aforementioned collision charging type electronic paper display device is a reflection type display device, it has memory effect. Accordingly, an erasing operation is required before a writing operation can be performed. In the general collision charging type electronic paper display device, waveforms having an opposite symbol of a voltage applied during the writing operation are simultaneously applied to the whole surface of the display device or selected scan lines, so as to perform the erasing operation.

FIG. 4A to FIG. 4C are driving waveforms illustrating various modes of erasing all the screens of an electronic paper by applying a reset pulse in accordance with the related art.

In FIG. 4A, the reset pulse is applied to the scan lines only. In FIG. 4B, the reset pulse is applied to the data lines only. In FIG. 4C, the reset pulse is applied to both the scan lines and the data lines. In this way, the whole screen is erased at once.

If the reset pulse is applied to the scan lines only, the data lines only, or both the scan lines and the data lines to erase the whole screen of the electronic paper at once, erasing is performed over the whole screen of the electronic paper before addressing is performed. In this case, a step of changing the whole screen to a black or white color is caused. This step, however, seriously deteriorates the picture quality realized by the screen. In this respect, the electronic paper which includes particles having memory effect requires a new driving method and apparatus for erasing and addressing each cell.

### SUMMARY OF THE INVENTION

Accordingly, the present invention is directed to a display panel and a method for driving the same, which substantially obviate one or more problems due to limitations and disadvantages of the related art.

An object of the present invention is to provide a display panel and a method for driving the same, in which the whole screen of an electronic paper is not erased at once before addressing, thereby improving the picture quality.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in a method for driving a display panel provided with a plurality of scan electrodes and a plurality of data electrodes, the method according to an embodiment of the present invention comprises applying a first voltage to each of pixels at a first frame; and applying a second voltage to each of pixels at a second frame, wherein the second voltage is determined by a variation of a reflection ratio at each of the pixels.

In another aspect of the present invention, in a method for driving a display panel provided with a plurality of scan electrodes and a plurality of data electrodes, the method comprises erasing pixels located in at least one of the scan electrodes; and applying a scan pulse to the scan electrode corresponding to the erased pixels, and applying a data pulse to the data electrodes.

In another aspect of the present invention, in a display panel provided with a plurality of scan electrodes and a plurality of data electrodes, the display panel comprises a scan driver and a data driver, which apply a reset pulse for erasing pixels located in at least one line of the plurality of scan electrodes.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a cell structure of a related art microcapsule type electronic paper display device;

FIG. 2 is a perspective view illustrating a cell structure of a related art dried electronic paper display device;

FIG. 3 illustrates driving waveforms of a related art matrix driving mode;

FIG. 4A to FIG. 4C are driving waveforms illustrating a mode of erasing the whole screen of a related art electronic paper at once;

FIG. 5 is a graph illustrating a variation of a reflection ratio, which is caused by a variation in the size of a driving pulse voltage of a passive type matrix electronic paper display device according to one embodiment of the present invention;

FIG. 6 is a table illustrating sizes of driving pulse voltages applied to pixels of an image frame of a passive type matrix electronic paper display device according to one embodiment of the present invention;

FIG. 7 is a graph illustrating a variation of a reflection ratio, which is caused by a variation in the size of a driving pulse voltage of an active type matrix electronic paper display device according to one embodiment of the present invention;

FIG. 8 is a table illustrating sizes of driving pulse voltages applied to a pixel of an image frame of an active type matrix electronic paper display device according to one embodiment of the present invention;

FIG. 9A to FIG. 9C are examples of driving waveforms illustrating a method for driving an electronic paper panel according to an embodiment of the present invention;

FIG. 10 illustrates scan line and data lines of an apparatus for driving an electronic paper panel in accordance with an embodiment of the present invention;

FIG. 11 is a block diagram illustrating an apparatus for driving an electronic paper panel in accordance with an embodiment of the present invention;

FIG. 12 is a detailed view illustrating a scan driver of FIG. 11; and

FIG. 13 is a detailed view illustrating a drive integrated circuit (IC) of a data driver of FIG. 11.

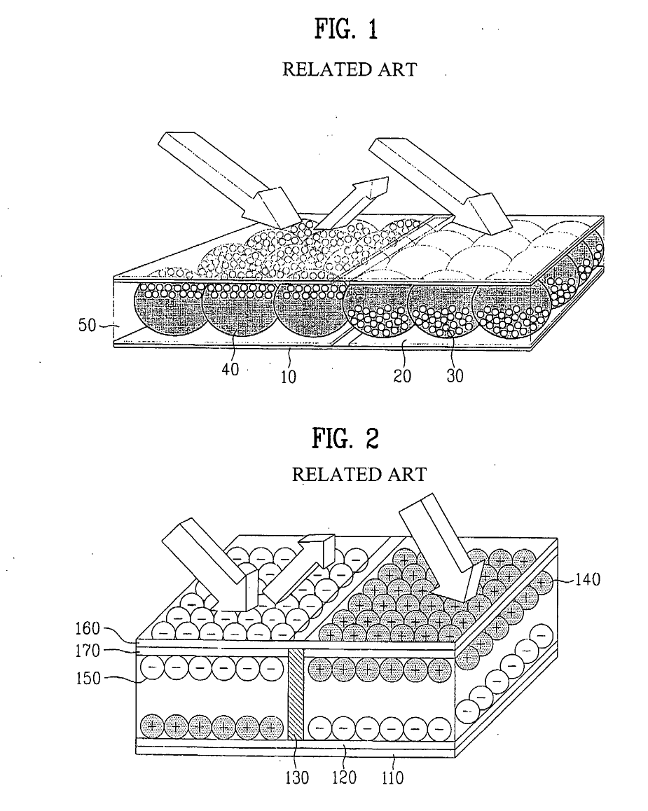

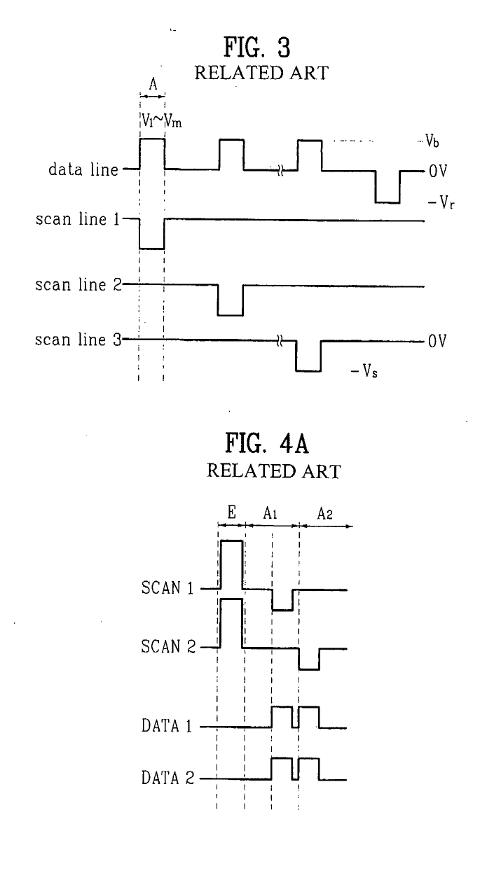

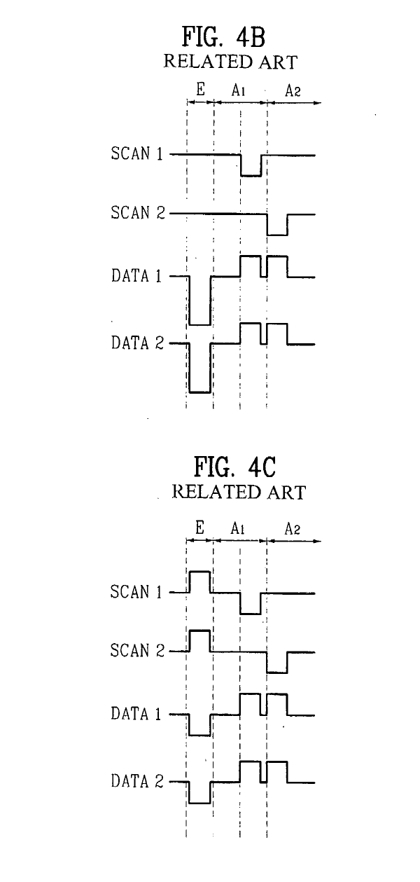

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

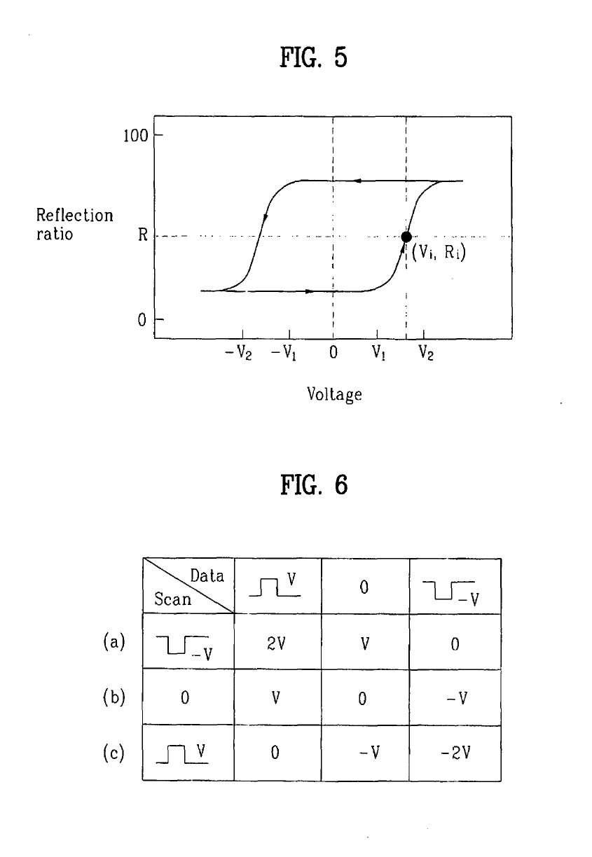

In a method for driving a display panel according to one embodiment of the present invention, a driving pulse voltage according to a size of a reflection ratio of a pixel is applied from an input frame to directly vary a reflection ratio without applying an erasing pulse voltage. Hereinafter, a method for driving a display panel according to one embodiment of the present invention will be described with reference to FIG. 5 to FIG. 8.

FIG. 5 is a graph illustrating an example of a variation of a reflection ratio, which is caused by a variation in the size of a driving pulse voltage of a passive type matrix electronic paper display device according to one embodiment of the present invention. As shown in FIG. 5, the passive type matrix electronic paper display device has a threshold value at V₁ and a saturated reflection ratio of a white color at V₂. Likewise, if the polarity of a voltage is changed to increase to a minus voltage, a threshold voltage is represented at −V₁, and a reflection ratio of a black color is saturated at −V₂.

FIG. 6 is a table illustrating sizes of driving pulse voltages applied to pixels of an image frame of a passive type matrix electronic paper display device according to one embodiment of the present invention. FIG. 6 illustrates voltages applied to pixels of a current image frame when driving pulse voltages of −V, 0 and V are respectively applied to the scan lines and the data lines. Among nine voltages applied to the pixels of the current image frame, −2V and 2V only vary a reflection ratio of the pixels. Since the other values −V, 0, and V are smaller than or equal to a threshold value, they do not vary the reflection ratio of the pixels.

For example, as shown in dots of FIG. 5, it is supposed that a reflection ratio is Rᵢ when a voltage Vᵢ is applied to the pixels of the current image frame. A reflection ratio of pixels of a next image frame, which are the same as those of a previous image frame, is greater or smaller than a previous reflection ratio Rᵢ. In this case, it is supposed that a reflection ratio greater than the previous reflection ratio Rᵢ is R_{large} and a reflection ratio smaller than the previous reflection ratio Rᵢ is Rₛₘₐₗₗ. If it is supposed that the reflection ratio is R_{large}, a voltage of −V is applied to the scan lines, and a voltage of V_{large}−V is applied to the data lines. Accordingly, a voltage V_{large} greater than Vᵢ and corresponding to R_{large} is applied to the pixels. At this time, a reflection ratio of the corresponding pixels is varied from Rᵢ to R_{large} along directivity shown in the graph of FIG. 5 without applying an erasing pulse voltage to the corresponding pixels.

Meanwhile, it is supposed that a reflection ratio Rₛₘₐₗₗ of the pixels of the next image frame, which are the same as those of the previous image frame, is smaller than a current reflection ratio Rᵢ. In this case, a voltage of V is applied to the scan lines, and a voltage of Vₛₘₐₗₗ+V is applied to the data lines. Accordingly, a driving pulse voltage smaller than −Vᵢ and corresponding to Rₛₘₐₗₗ is applied to the pixels of the current image frame. In this case, the reflection ratio of the corresponding pixels is varied from Rᵢ to Rₛₘₐₗₗ along directivity shown in the graph of FIG. 5 without applying an erasing pulse voltage of −V₂ or V₂ corresponding to white or black.

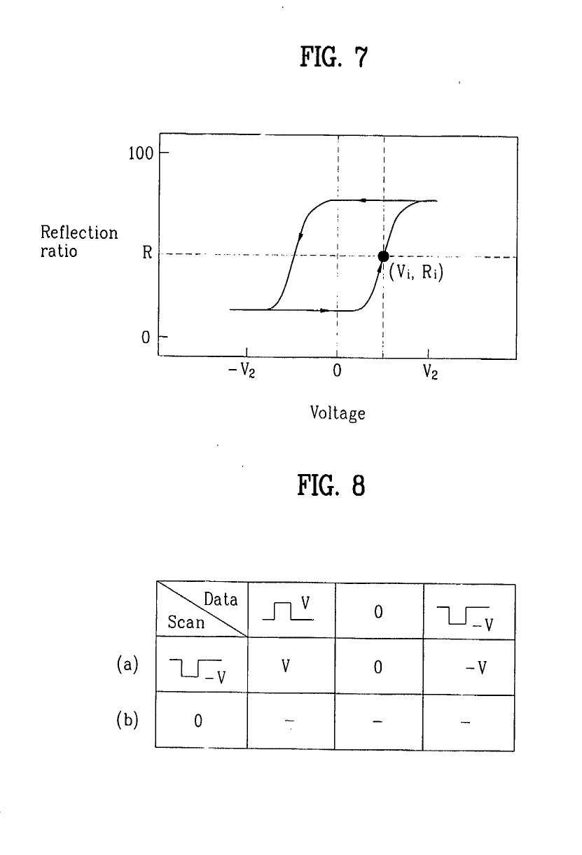

FIG. 7 is a graph illustrating an example of a variation of a reflection ratio, which is caused by a variation in the size of a driving pulse voltage of an active type matrix electronic paper display device according to one embodiment of the present invention. As shown in FIG. 7, in the active type matrix electronic paper display device having no threshold value, the reflection ratio starts to increase at 0V, and a reflection ratio of white is saturated at V₂. Likewise, if the polarity of the voltage is varied to increase the voltage to reach a minus voltage, the reflection ratio starts to decrease at 0V, and a reflection ratio of black is saturated at −V₂.

FIG. 8 is a table illustrating sizes of driving pulse voltages applied to pixels of an image frame of an active type matrix electronic paper display device according to one embodiment of the present invention. FIG. 8 illustrates voltages applied to pixels of a current image frame when driving pulse voltages of −V and 0 are applied to the scan lines, and driving pulse voltages of −V, 0 and V are applied to the data lines.

For example, as shown in dots of FIG. 7, it is supposed that a reflection ratio is Rᵢ when a voltage Vᵢ is applied to the pixels of the current image frame. A reflection ratio of the pixels of the next image frame, which are the same as those of the previous image frame, is greater or smaller than the previous reflection ratio Rᵢ. In this case, it is supposed that a reflection ratio greater than the previous reflection ratio Rᵢ is R_{large} and a reflection ratio smaller than the previous reflection ratio Rᵢ is Rₛₘₐₗₗ. If it is supposed that a reflection ratio is R_{large}, a driving pulse voltage of V_{large} greater than Vᵢ and corresponding to R_{large} is applied to the pixels. At this time, a reflection ratio is directly varied from Rᵢ to R_{large} without applying any erasing pulse voltage to the corresponding pixels of the current image frame.

Meanwhile, it is supposed that a reflection ratio Rₛₘₐₗₗ of the pixels of the next image frame, which are the same as those of the previous image frame, is smaller than a reflection ratio Rᵢ of the pixels of the current image frame. In this case, a voltage smaller than −Vᵢ and corresponding to Rₛₘₐₗₗ is applied to the pixels of the current image frame. In this case, a reflection ratio of the corresponding pixels is varied from Rᵢ to Rₛₘₐₗₗ along directivity shown in the graph of FIG. 7 without applying an erasing pulse voltage of −V₂ or V₂ corresponding to white or black, in the same manner as described above.

In other words, in the general method for driving an electronic paper display device, to display an image frame, an erasing operation is required before a writing operation due to memory effect in which a previous image frame is displayed as an afterimage. However, in the method for driving an electronic paper display device in accordance with the embodiment of the present invention, an image frame can directly be displayed regardless of a driving mode by applying a driving pulse voltage according to a reflection ratio of pixels of an image frame without applying an erasing pulse voltage.

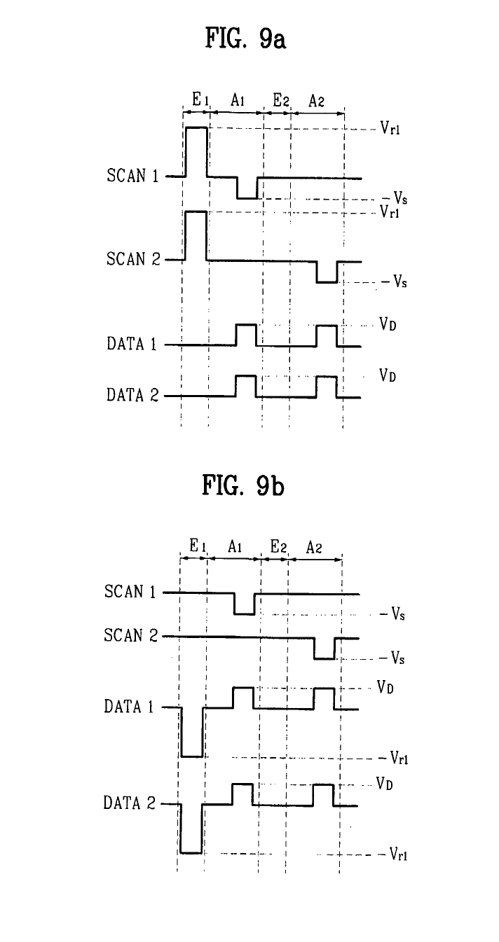

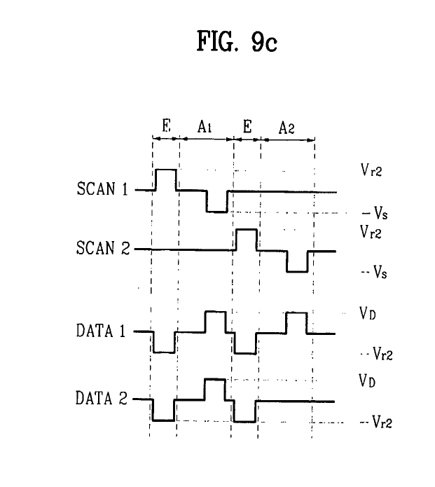

In a method for driving a display panel according to another embodiment of the present invention, an erasing voltage is applied to some of the scan lines to erase pixels located in corresponding scan lines. Hereinafter, the method for driving a display panel according to another embodiment of the present invention will be described with reference to FIG. 9A to FIG. 9C.

In FIG. 9A, a reset pulse Vr₁ is applied to the scan lines only to erase pixels of the display panel. In other words, pixels of one (SCAN 1) of the plurality of scan lines are erased. In this case, the erasing operation can be performed by applying the reset pulse Vr₁ to the scan line SCAN 1 as shown. A scan pulse −Vs is applied to the corresponding scan line SCAN 1 of the erased pixels, and a data pulse V_{D} synchronized with the scan pulse −Vs is applied to a plurality of data lines DATA 1 and DATA 2. In this way, the addressing operation is performed.

Accordingly, in the erasing method according to the embodiment of the present invention, unlike the related art erasing method which erases the whole screen as a black or white color at once, the pixels corresponding to only one of the scan lines are erased and then pixels corresponding to the other one (or another one) of the scan lines are erased. In other words, since any one scan line selected from the scan lines undergoes erasing and addressing operations, picture quality is prevented from being deteriorated.

In FIG. 9B, a reset pulse −Vr₁ is applied to the data lines only to erase pixels of the display panel. In other words, pixels of one (SCAN 2) of the plurality of scan lines are erased. In this case, the erasing operation can be performed by applying the reset pulse −Vr₁ to the scan line SCAN 2. In this case, the reset pulse −Vr₁ is applied to the data lines DATA 1 and DATA 2 to erase the pixels of the scan line SCAN 2. To erase the pixels corresponding to the scan line SCAN 2, the reset pulse −Vr₁ should be applied to all the data lines DATA 1 and DATA 2.

In the aforementioned driving method, even if a cell is turned off after the scan pulse is applied (cell is turned on) to any one (SCAN 1) of the scan lines, motion of charges does not occur, whereby the on-state of the cell can be maintained as it is. Afterwards, the scan pulse −Vs is applied to the corresponding scan line SCAN 2 of the erased pixels, and the data pulse V_{D} synchronized with the scan pulse −Vs is applied to the data lines DATA 1 and DATA 2. In this way, the addressing operation is performed as described above.

In FIG. 9C, reset pulses Vr₂ and −Vr₂ are applied to both the scan lines and the data lines to erase pixels of the display panel. In other words, pixels of one (SCAN 1) of the plurality of scan lines are erased. In this case, the erasing operation can be performed by applying the reset pulses Vr₂ and −Vr₂ to the scan line SCAN 1 and the data lines DATA 1 and DATA 2. First, the scan pulse −Vs is applied to the corresponding scan line SCAN 1 of the erased pixels. Then, addressing operation is performed in such a manner that the data pulse V_{D} synchronized with the scan pulse −Vs is applied to the data lines DATA 1 and DATA 2.

In this case, the reset pulses Vr₂ and −Vr₂ applied to the scan line SCAN 1 and the data lines DATA 1 and DATA 2 erase the pixels corresponding to one (SCAN 1) of the plurality of scan lines. To this end, the reset pulses are applied to the selected scan line SCAN 1 only to erase the pixels of the scan line SCAN 1.

In the aforementioned embodiment, the erasing operation and addressing operation can be applied to the data lines and the scan lines in turn. The pixels can be erased by applying the reset pulses to at least one of the scan lines and the data lines. In other words, the reset pulses are applied to the scan lines (e.g., as shown in FIG. 9A), the data lines (e.g., as shown in FIG. 9B), or both the scan lines and the data lines (e.g., as shown in FIG. 9C). In this case, the reset pulses applied to the scan lines and the reset pulses applied to the data lines have different voltages from each other.

As described above, while erasing and addressing operations are performed for each of the scan lines, the reset pulse Vr₁ is not applied to the scan line SCAN 1 but applied to another scan line SCAN 2, wherein the scan line SCAN 1 has undergone the addressing operation as the scan pulse −Vs and the data pulses DATA 1 and DATA 2 are applied thereto (cell is turned on), and the other scan line SCAN 2 has not undergone the addressing operation. Accordingly, the erasing and addressing operations do not affect motion of charges in the cell previously addressed, and the cell is maintained as it is turned on. A width of the reset pulse Vr₁ and its voltage level are set so as not to affect adjacent scan lines.

Since the reset pulse Vr₁ has a low response speed in view of properties of the electronic paper display device, a pulse having a wide width and a high voltage level is supplied to quickly vary the state of the cell, whereby contrast and the response speed of the cell can be controlled quickly. In other words, it is preferable that the width of the reset pulse and its voltage level Vr₁ are wider and greater than a width and a voltage level −Vs or V_{D} of the scan pulse or the data pulse.

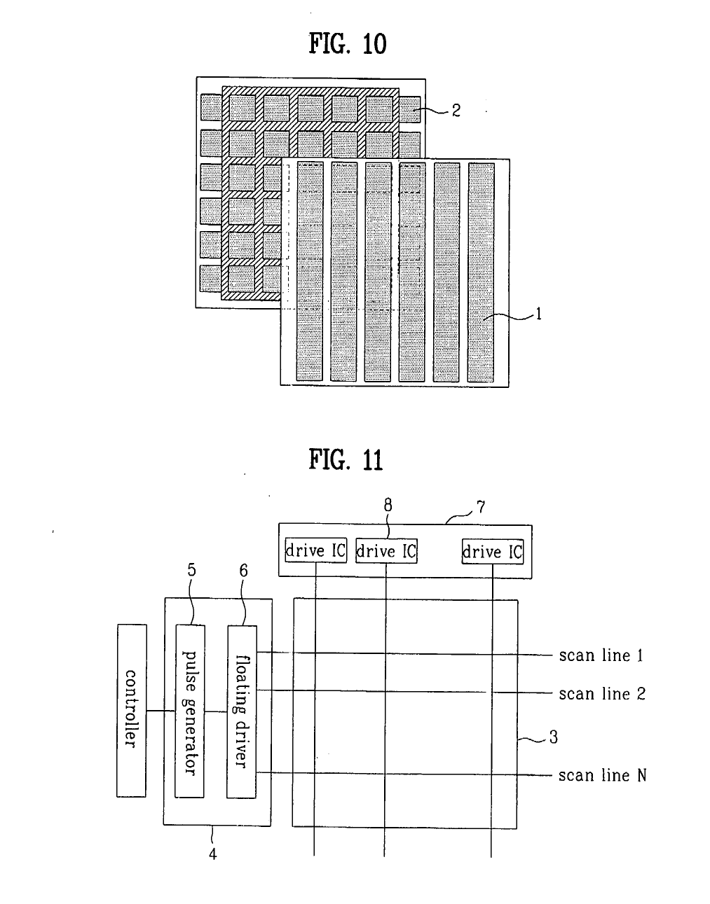

Hereinafter, a display device according to one embodiment of the present invention will be described with reference to FIG. 10 to FIG. 13.

FIG. 10 illustrates the scan and data lines of an apparatus for driving an electronic paper panel in accordance with an embodiment of the present invention, and FIG. 11 is a block diagram illustrating the apparatus for driving an electronic paper panel in accordance with an embodiment of the present invention. As shown in FIGS. 10 and 11, the electronic paper according to the preferred embodiment of the present invention includes a driving apparatus provided with a plurality of data lines 1 and a plurality of scan lines 2, which apply driving voltages. The driving apparatus includes a scan driver 4 and a data driver 7, which apply a reset pulse to erase pixels of one of the plurality of scan lines 2. The scan driver 4 applies a scan pulse to each of the scan lines 2 to which the reset pulse is applied. Also, the data driver 7 applies a data pulse, synchronized with the scan pulse, to the data lines 1 to perform the addressing operation.

In more detail, in one of the preferred embodiments of the present invention, the plurality of data lines D1˜Dm vertically cross the plurality of scan lines SCAN LINE 1˜SCAN LINE N as shown in FIGS. 10 and 11. The apparatus for driving an electronic paper panel according to the preferred embodiment of the present invention includes an electronic paper display panel 3 whose cells exist in positions where the data lines cross the scan lines, and the scan and data drivers 4 and 7 which apply the reset pulse to erase pixels corresponding to any one of the plurality of scan lines 2 as shown in FIG. 11.

In this case, the reset pulse can erase any one of the plurality of scan lines 2. At least one of the scan driver 4 and the data driver 7 can apply the reset pulse. In other words, the scan driver 4, the data driver 7, or both the scan driver 4 and the data driver 7 can apply the reset pulse to one or more of the scan lines and/or data lines.

As described above, the scan driver 4 which applies the reset pulse can erase pixels of one of the plurality of scan lines 2 by applying the reset pulse to any one of the plurality of scan lines 2. The data driver 7 which applies the reset pulse can erase pixels of one of the plurality of scan lines 2 by applying the reset pulse to the plurality of data lines 1.

In one of the preferred embodiments of the present invention, the pixels corresponding to any one of the plurality of scan lines 2 are erased using the scan driver 4 and the data driver 7. Subsequently, the addressing operation is performed in such a manner that the scan pulse and the data pulse are applied to each of the scan lines to which the reset pulse is applied. In other words, the scan driver 4 according to the preferred embodiment of the present invention applies the scan pulse to each of the scan lines in such a manner that the scan pulse is applied to any one of the scan lines 2, to which the reset pulse is applied. Subsequently, the scan driver 4 applies the scan pulse to the other scan line to which the reset pulse is applied.

To this end, the scan driver 4 according to one of the preferred embodiments of the present invention includes a plurality of switching means and applies the scan pulse to each of the scan lines to which the reset pulse is applied. The data driver 7 includes a plurality of switching means, and a plurality of drive integrated circuits (ICs) 8 which apply the data pulse synchronized with the scan pulse to the plurality of data lines. The scan driver 4 includes a pulse generator 5 which outputs the reset pulse or the scan pulse to erase any one of the plurality of scan lines using an externally input control signal. Also, the scan driver 4 includes a floating driver 6 which applies a predetermined pulse signal output from the pulse generator 5 to either a new scan line which is not erased or the scan line which is erased as the reset pulse is applied thereto. A controller for controlling the scan driver 4 and/or the data driver 7 can be provided.

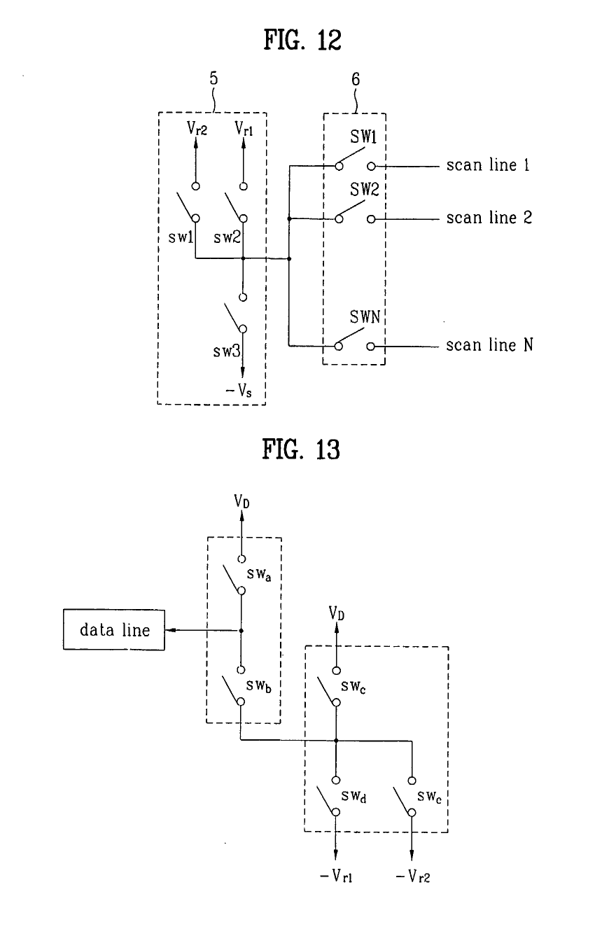

FIG. 12 is a detailed view illustrating an example of the scan driver 4 of FIG. 11 according to an embodiment of the present invention. As shown in FIG. 12, the pulse generator 5 includes a plurality of switching means (or switches) sw1˜sw3. The pulse generator 5 outputs the reset pulse Vr₁ or Vr₂ for erasing pixels of one of the plurality of scan lines or the scan pulse −Vs having a predetermined voltage for each of the scan lines to which the reset pulse is applied. The pulse generator 5 outputs the voltage Vr₁ only if the reset pulse is applied to the scan driver only. The pulse generator 5 outputs the voltage Vr₂ if the reset pulse is applied to both the scan driver and the data driver. Then, the floating driver 6 applies the predetermined pulse signal (reset pulse or scan pulse) output from the pulse generator 5 to the selected one of the scan lines of the floating state. The floating driver 6 includes a plurality of switches SW1-SWN.

FIG. 13 is a detailed view illustrating an example of the drive IC 8 of the data driver 7 of FIG. 11 according to an embodiment of the present invention. As shown in FIG. 13, the drive IC 8 includes a plurality of switching means (or switches) SWa˜SWe. The drive IC 8 outputs the reset pulse −Vr₁ or −Vr₂ for erasing pixels of one of the plurality of scan lines or the data pulse V_{D} having a predetermined voltage, wherein the data pulse V_{D} is synchronized with the scan pulse output from the scan driver. In this case, the drive IC 8 outputs the voltage −Vr₁ if the reset pulse is applied to the data driver only. The drive IC 8 outputs the voltage −Vr₂ to the data lines 1 of the electronic paper display panel 3 if the reset pulse is applied to both the scan driver and the data driver.

The plurality of switching means (switches) provided in the pulse generator 5 and the floating driver 6 and the plurality of switching means (switches) constituting the drive IC 8 are controlled (turned on or off) by predetermined switching control signal(s) output from an external controller. The control signal applied to each of the switching means of the floating driver 6 is an off-switching control signal, and all the scan lines SCAN LINE 1˜SCAN LINE N lie in a floating state. An on-switching control signal is input to the selected scan line for a predetermined time period so that a predetermined pulse signal output from the pulse generator 5 is applied to the selected scan line.

Hereinafter, the operation of the apparatus for driving a display panel according to a preferred embodiment of the present invention will be described with reference to FIG. 11 to FIG. 13.

First, the reset pulse which erases pixels corresponding to one of the plurality of scan lines is applied. At this time, the erasing operation may be performed when a voltage is first applied to the screen, or the erasing operation may be performed in such a manner that a specific scan line is erased and then the other scan line(s) are erased. Also, any one of the scan lines according to the present invention may be in a floating state before an addressing signal is applied by the scan pulse and the data pulse.

To arrange the scan line of the floating state under the black or white state, the reset pulse Vr₁ having a predetermined width and direction is applied through the scan driver 4. In other words, the switching means sw2 of the pulse generator 5 in the scan driver 4 and the switching means SW1 of the floating driver 6 are turned on for a predetermined time period to apply the reset pulse Vr₁ to the scan line SCAN LINE 1, whereby cells of the floating state are maintained to be erased. At this time, a ground voltage GND of 0V is applied to all the data lines.

To address cells of the scan line erased by the reset pulse Vr₁, the scan pulse is applied to the scan line. For example, to drive cells connected with the first scan line SCAN LINE 1, the switching means sw3 of the pulse generator 5 and the switching means SW1 of the floating driver 6 are turned on so that the scan pulse having a voltage level of −Vs is applied to the first scan line among the scan lines of the floating state. In this case, the scan lines other than the scan line, which is selected for a time period when the scan pulse is applied, are floated. Accordingly, unlike the related art driving mode, no voltage is applied to cells which are not selected.

At the same time, or subsequently, to drive the cells, the data pulse synchronized with the scan pulse is applied to the plurality of data lines. For example, if frame data for driving a specific cell is externally input, each drive IC 8 of the data driver 7 outputs the data pulse for driving the cells to the data lines. In other words, the switching means SWa is turned on for a predetermined time period by the externally input switching control signal and then turned off to output the voltage V_{D}. The switching means SWb and SWc are turned on to output the ground voltage GND, so that the data pulse having a voltage level of V_{D} is applied to the data lines. The data pulse applied to the plurality of data lines is synchronized with the scan pulse applied to the first scan line so that the cells connected with the first scan line are driven to display predetermined data.

The aforementioned operation is performed from the first scan line (SCAN LINE 1) to the last scan line (SCAN LINE N) in turn. In other words, after the reset pulse is input to erase the cell pixels corresponding to any one of the plurality of scan lines, the scan pulse and the data pulse synchronized with the scan pulse are applied to the erased scan line. In this way, the addressing operation is performed from the first scan line to the last scan line in turn.

It will be apparent to those skilled in the art that the aforementioned operations according to the embodiments can be applied cases wherein the erasing operation is performed for only the data lines, or only the scan lines, or both the data lines and the scan lines. Also the method(s) discussed in the present application can be implemented in the devices shown in any of the figures, or in other suitable devices and/or systems. The devices discussed in the present invention, e.g., the display panel device, can include other components known in the art, which may not be shown.

Furthermore, since motion of charges does not occur even if the cell is turned off after the scan pulse is applied (cell is turned on) to any one scan line, the on-state of the cell is maintained. Accordingly, the reset pulse and the scan pulse applied to the scan line to which the reset pulse is applied can have different voltages from each other. Likewise, the reset pulse and the data pulse applied to the data line to which the reset pulse is applied can have different voltages from each other. Moreover, in the preferred embodiments of the present invention, since the scan pulse and the data pulse have different voltages from each other to divide the voltages applied to the cell, it is possible to lower the voltage of the drive IC, thereby reducing the cost caused by the drive IC.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for driving a display panel provided with a plurality of scan electrodes and a plurality of data electrodes, the method comprising:
applying a first voltage to each of pixels at a first frame; and
applying a second voltage to each of pixels at a second frame, wherein the second voltage is determined by a variation of a reflection ratio at each of the pixels.

2. The method as claimed in claim 1, wherein the display panel is an electronic paper display device.

3. The method as claimed in claim 1, wherein no erasing voltage is applied to each discharge cell between the first frame and the second frame.

4. The method as claimed in claim 2, wherein the electronic paper display device is a passive type matrix display device, and
wherein if a reflection ratio of the first frame is greater than that of the second frame, a voltage of −V is applied to the scan electrodes while a voltage of V_{large}−V is applied to the data electrodes after the first frame ends, wherein V is a random value, and V_{large} is a voltage applied to each pixel at the second frame.

5. The method as claimed in claim 2, wherein the electronic paper display device is a passive type matrix display device, and
wherein if a reflection ratio of the first frame is smaller than that of the second frame, a voltage of V is applied to the scan electrodes while a voltage of Vₛₘₐₗₗ+V is applied to the data electrodes after the first frame ends, wherein V is a random value, and V ₛₘₐₗₗ is a voltage applied to each pixel at the second frame.

6. The method as claimed in claim 2, wherein the electronic paper display device is an active type matrix display device, and
wherein if a reflection ratio of the first frame is greater than that of the second frame, a voltage of V_{large} is applied to each pixel after the first frame ends, wherein V_{large} is a voltage applied to each pixel at the second frame.

7. The method as claimed in claim 2, wherein the electronic paper display device is an active type matrix display device, and
wherein if a reflection ratio of the first frame is smaller than that of the second frame, a voltage of Vₛₘₐₗₗ is applied to each pixel after the first frame ends, wherein Vₛₘₐₗₗ is a voltage applied to each pixel at the second frame.

8. A method for driving a display panel provided with a plurality of scan electrodes and a plurality of data electrodes, the method comprising:
a) erasing pixels located in at least one of the scan electrodes; and
b) applying a scan pulse to the scan electrode corresponding to the erased pixels, and applying a data pulse to the data electrodes.

9. The method as claimed in claim 8, wherein the display panel is an electronic paper display device.

10. The method as claimed in claim 8, wherein the a) and b) are sequentially applied to lines of both the plurality of scan electrodes and the plurality of data electrodes.

11. The method as claimed in claim 8, wherein the a) includes applying a reset pulse to the scan electrodes or the data electrodes.

12. The method as claimed in claim 8, wherein the a) includes applying a reset pulse to the scan electrodes and the data electrodes, and the reset pulse applied to the scan pulses and the data pulse applied to the data electrodes have different polarities from each other.

13. A display panel comprising:
a plurality of scan electrodes and a plurality of data electrodes; and
a scan driver for driving the scan electrodes and a data driver for driving the data electrodes, wherein at least one of the scan and data drivers applies a reset pulse for erasing pixels located in at least one line of the plurality of scan electrodes.

14. The display panel as claimed in claim 13, wherein the scan driver applies a scan pulse to each of the scan lines to which the reset pulse is applied.

15. The display panel as claimed in claim 14, wherein the scan driver applies a scan pulse to the plurality of scan lines in turn.

16. The display panel as claimed in claim 13, wherein the data driver applies a data pulse to the plurality of data electrodes, the data pulse being synchronized with the scan pulse.

17. The display panel as claimed in claim 13, wherein either the scan driver or the data driver applies a scan pulse.

18. The display panel as claimed in claim 13, wherein the data driver applies a reset pulse to the plurality of data electrodes.

19. The display panel as claimed in claim 16, wherein the scan driver includes:
a pulse generator outputting any one of the scan pulse and the reset pulse; and
a floating driver applying a pulse signal output from the pulse generator to at least one of the scan electrodes.

20. The display panel as claimed in claim 16, wherein the data driver includes:
drive ICs outputting any one of the reset pulse and the data pulse.
